(19) United States
(12) Patent Application Publication
(10) Pub. No.: US 2010/0299510 A1
(43) Pub. Date: Nov. 25, 2010

(54) BLUETOOTH PRE-BOOT AUTHENTICATION IN BIOS

(76) Inventors: Chip Ueltschey, Beaverton, OR (US); Dale Jurich, Los Gatos, CA (US); Timothy Lewis, El Dorado Hills, CA (US)

Correspondence Address: Phoenix Technologies Ltd.;ATTN: Legal Dept., 915 Murphy Ranch Road, Milpitas, CA, 95035, US

(21) Appl. No.: 12/719,142

(22) Filed: Mar. 8, 2010

Related U.S. Application Data
(60) Provisional application No. 61/216,672, filed on May 19, 2009.

(51) Int. Cl. G06F 21/00; G06F 15/177; G06F 9/24

(52) U.S. Cl. 713/2; 726/16

(57) ABSTRACT

The disclosed invention includes, among other things, methods and techniques for controlling usage of a computing device in the form of a Bluetooth® capable portable electronic device that provides for authentication of the computing device prior to any operating system being loaded onto the computing device. The portable electronic device operates cooperatively with the computing device to provide authentication information, such as the portable electronic device's Bluetooth device information. Previously developed implementations have shortcomings especially in the degree of security provided that are overcome by the present invention, especially its operation in a pre-boot environment.

### RELATED APPLICATION

This application claims the benefit of U.S. Provisional Application Ser. No. 61/216,672 filed on May 19, 2009.

### FIELD OF THE INVENTION

The present invention generally relates to personal computers and devices sharing similar architectures and, more particularly relates to a system and corresponding method for controlling usage of, and access to, a PC (personal computer) through authentication prior to bootstrap loading of an OS (operating system) or like instruction codes.

### BACKGROUND OF THE INVENTION

Electronic devices, for example, laptop computers, netbooks, palmtop computers, personal digital assistants, cellular communications devices, point of sales machines and other suitable devices and combinations thereof have become an integral component in the mobile work force. Where personnel were once limited to working at a desktop or other static location, the advent of laptop computers and other mobile personal computing devices has made mobile computing more the rule than the exception. Mobility, though, has its disadvantages. First, lost and/or stolen computers have greatly increased the amount of sensitive information that has been leaked into public view. An unfortunate by-product of such information loss has been an increase of identity theft over the past several years.

Additionally, the tremendous decrease in productivity resulting from the user reporting the lost/stolen computer incident, replacing and configuring a replacement system to equal that of the previous computer, potentially having to perform many projects for a second, third or more times and taking steps to ensure their identity has not been stolen, for example, reporting the incident to banks, credit card companies, credit bureaus and other corresponding organizations can potentially result in large sums of money for lost productivity time that companies and individuals cannot easily recoup. As a result of increasing incidents of lost/stolen computers, efforts have been undertaken to reduce some potential risks associated with such incidents.

One such effort has been to equip computers, in particular laptop computers, with various authentication means. A tradeoff may exist between the frequency and the intrusiveness of authentication subsystems versus the amount of unauthorized usage of the computer that may occur after a computer has been compromised and before an authentication exception prevents an unauthorized user from making further use of the computer.

Since computers may typically be most vulnerable to theft and/or compromise when they are shut down, a need exists to ensure that authentication takes place early in every computer start-up sequence that is minimally intrusive to the user but at that same time provides robust authentication with an elimination of false positive authentications.

Bootloading (sometimes booting or Bootstrap loading) is a term of art well known in PC (personal computer) design, implementation and usage that encompasses substantial portions or all of the startup sequence of PCs. Bootloading typically includes a reset to a fixed CPU (central processing unit) mode and instruction pointer address; for most common types of PC this would be so-called Real Mode at real address CS:IP FFFF:0000 equivalent to flat address 0x000FFFF0.

A typical sequence typically starts with very early code for bringing up the CPU and so-called chipset, such as by running low speed serial protocols to discover the types and amount of RAM (Random Access Memory) and other storage present and initializing it. Next, and fairly early in the boot process may come a POST (Power-On self-test), followed by further configuration using semiconductor memory.

Relatively late in the process but still in the so-called pre-boot environment (another term of art commonly understood in the computer arts) may be a secondary Bootloader program. Secondary Bootloader programs may provide for alternative loading (sometimes termed dual boot or multi-boot) of well known programs such as GRUB (Grand Unified Bootloader), BOOTMGR (Bootstrap manager), LILO (Linux Loader), NTLDR (New Technology loader, or sometimes Needs Time Loader). Alternatively the secondary Bootloader may load a Hypervisor or VMM (Virtual Machine Manager).

Towards the end of the bootstrap process an OS (Operating System) program is loaded, usually from disk storage (or less often FLASH memory that emulates disk storage). OSes are also well known in the art and provide system services for (and the loading of) application programs. Modern OSes typically provide for Cascade Loading wherein application programs can themselves implicitly and explicitly invoke further loaders.

Most security systems for PCs are built on OSes because OSes, by design, provide relatively easy facilities for the addition of features, including security systems. One such system relies on Bluetooth® communication with a Screen-Saver environment, however as alluded to above this has a disadvantage that is occurs late in the computer loading process. Being late loaded causes the security code itself be a relatively easy target for unauthorized changes.

Other security systems may operate in a pre-boot environment. However, software, and especially hardware-specific firmware, that may run early in the loading sequence is relatively difficult to modify and has been limited in features. Passwords have been implemented in such a context but have well-known disadvantages and inconveniences. Specialist hardware such as fingerprint scanners exist with various tradeoffs.

Thus, there remains significant room for improvement in security systems that combine the advantages of the various systems described above while avoiding the attendant disadvantages to a degree that provides a better tradeoff than with previously developed solutions.

### SUMMARY OF THE INVENTION

A platform management device in the form of a Bluetooth® capable electronic device provides for authentication prior to any operating system being loaded onto a computer that interoperates or incorporates (in whole or part) embodiments of the present invention.

A computing device comprising a processor, a radio, and means for operating the radio to establish a communications connection with a corresponding portable electronic device is provided. Additional capabilities include operating the radio to receive authentication information a corresponding portable electronic device; and responsively inducing further bootloading upon verification of the authorization information.

Further included is portable electronic device enrollment, later authorization is based on enrollment information.

A feature provided by the present invention is that Bluetooth based authentication occurs in a pre-boot environment.

A further advantage provided by the present invention is that it may provide for two factor authentication before a laptop computer may be operated.

### BRIEF DESCRIPTION OF THE DRAWINGS

The aforementioned and related advantages and features of the present invention will become better understood and appreciated upon review of the following detailed description of the invention, taken in conjunction with the following drawings, which are incorporated in and constitute a part of the specification, illustrate an embodiment of the invention and wherein like numerals represent like elements, and in which:

FIG. 1 is a schematic block diagram of a computing device configured to implement the security functionality according to the present invention;

FIG. 2 is a schematic block diagram of an electronic device of an embodiment of the invention and configured to work in conjunction with a portable electronic device being used as a platform management device;

FIG. 3 is a flow chart illustrating acts performed in concert with a portable electronic device within the scope of an embodiment of the invention;

FIG. 4 is a flow chart illustrating acts performed in concert with a portable electronic device within the scope of another aspect or another embodiment of the invention;

FIG. 5 shows how an exemplary embodiment of the invention may be encoded onto a computer medium or media; and

FIG. 6 shows how an exemplary embodiment of the invention may be encoded, transmitted, received and decoded using electro-magnetic waves.

### DETAILED DESCRIPTION OF THE INVENTION

The numerous components shown in the drawings are presented to provide a person of ordinary skill in the art a thorough, enabling disclosure of the present invention. The description of well known components is not included within this description so as not to obscure the disclosure or take away or otherwise reduce the novelty of the present invention and the main benefits provided thereby.

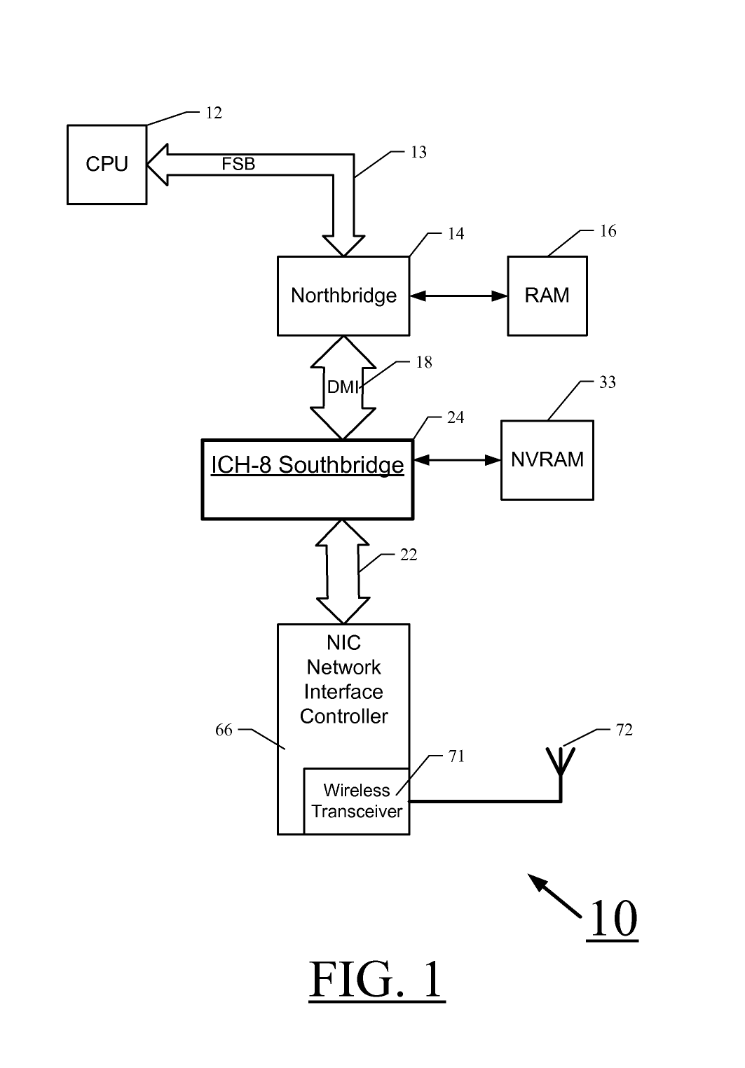

FIG. 1 is a schematic block diagram of a computing device configured to implement the security functionality according to embodiments of the present invention.

In an exemplary embodiment, the computing device 10 may be implemented as a personal computer, for example, a desktop computer, a laptop computer, a tablet PC, netbook or other suitable computing device. Although the description outlines the operation of a personal computer, it will be appreciated by those of ordinary skill in the art, that the computing device 10 may be implemented as a PDA, wireless communication device, for example, a cellular telephone, embedded controllers or devices, for example, set top boxes, printing devices or other suitable devices or combination thereof suitable for operating or interoperating with the invention.

The computing device 10 may include at least one processor or CPU (Central Processing Unit) 12, configured to control the overall operation of the computing device 10. Similar controllers or MPUs (Microprocessor Units) are commonplace. CPU 12 may typically be coupled to a bus controller 14 such as a Northbridge chip by way of a bus 13 such as a FSB (Front-Side Bus). The bus controller 14 may typically provide an interface for read-write system memory 16 such as RAM (random access memory).

The bus controller 14 may also be coupled to a system bus 18, for example a DMI (Direct Media Interface) in typical Intel® style embodiments. Coupled to the system bus 18 may be a so-called Southbridge controller chip 24. Also, typically, Southbridge chip 24 may also be coupled to a NVRAM (non-volatile random-access memory) 33.

In an embodiment, the bus controller 14 may provide for a connection 22 to a NIC (Network Interface Controller) 66 which may be a wireless NIC which drives a Wireless Transceiver 71. Wireless Transceiver 71 may operate in compliance with Bluetooth® standards. Wireless Transceiver 71 will typically include an RF (Radio Frequency) circuit coupled to some form of radiating antenna 72.

Radiating antenna in general facilitates a wireless communications channel with a portable electronic device used for authentication purposes.

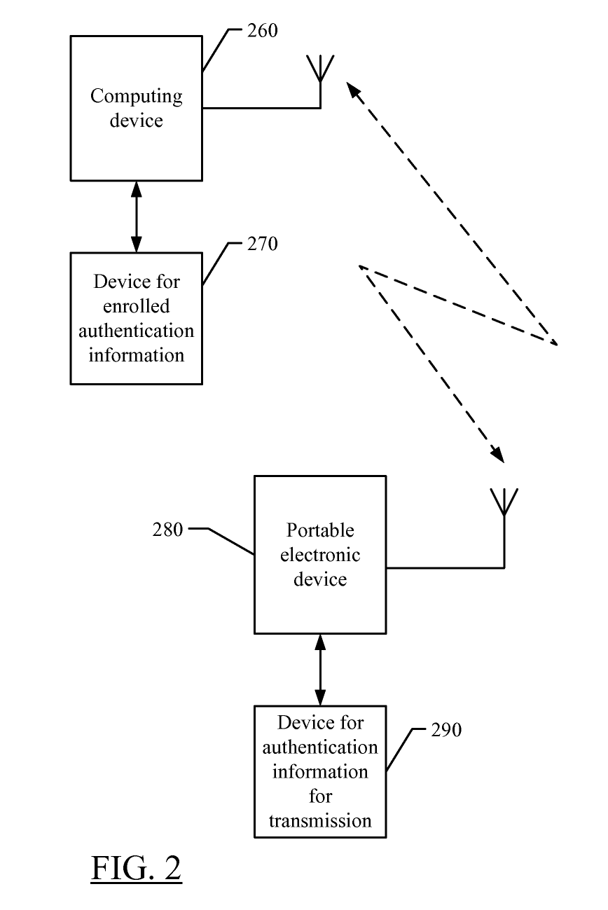

FIG. 2 is a schematic block diagram of a computing device 260 of an embodiment of the invention configured to work in conjunction with a portable electronic device 280 being used as a platform management device. In an embodiment of the invention portable electronic device 280 may be a Bluetooth® capable wireless telephone set, commonly termed a cellphone.

In general, computing device 260 and portable electronic device 280 mutually communicate using Bluetooth® protocols and mutually authenticate each other.

Computing device 260 stores enrolled authentication information 270, such as in a NVRAM device (such as ref. 33 of FIG. 1). Equally portable electronic device 280 may store authentication information for transmission in any of various forms or devices 290. In some embodiments of the invention a separate device 290 may not be provided and authentication information may be inherent or inferred, such as the Bluetooth® device address associated with the portable electronic device (not shown in the figure but which is present in Bluetooth® capable devices).

Referring briefly back to FIG. 1, as is well-known in the art, a processor comprised within the computing device fetches or otherwise obtains coded instructions from one or more memories and interprets the codes and executes them responsively to perform various acts.

In embodiments of the invention, acts of authentication are performed wholly or substantially in a pre-boot environment. Authentication can be accomplished using communications through direct wired interconnection (such as a USB (Universal Serial Bus) arrangement, not shown in the figures) to a port on the platform management device. Alternatively, and more typically, the interconnection can be accomplished wirelessly through transceivers of the respective devices. Embodiments of the invention are especially well adapted to communication using radios conforming to Bluetooth® protocols. Each radio may comprise a transceiver or alternative a transmitters and a receiver separately.

Provision of Bluetooth® protocol stacks is not commonly found in pre-boot environments. However, embodiments of the invention provide for Bluetooth® protocol stacks implemented in BIOS, EFI firmware or sometimes in embedded system Bootloading firmware. Such firmware, pre-boot provision of Bluetooth® services will typically be less than fully featured as might be the norm with the previously developed OS-based Bluetooth® protocol stacks.

Notwithstanding the connection mechanism, the acts described below may be performed to provision a computing device in embodiments of the invention. The processor accesses a memory, which may typically be a ROM that is used to store at least a part of a BIOS, and EFI firmware program or an embedded system startup firmware. Instructions may be fetched and executed directly from the memory (ROM or etc.) or alternatively the instruction codes may be copied to another memory, especially a shadow RAM for fetch and execution therefrom. Thus, a first memory, holding instructions to direct a first part of the process may be resident in, and fetched from, either RAM or ROM or a similar semiconductor technology (e.g. Flash memory, a specific type of EEPROM (Electrically Erasable Programmable Read-Only Memory).

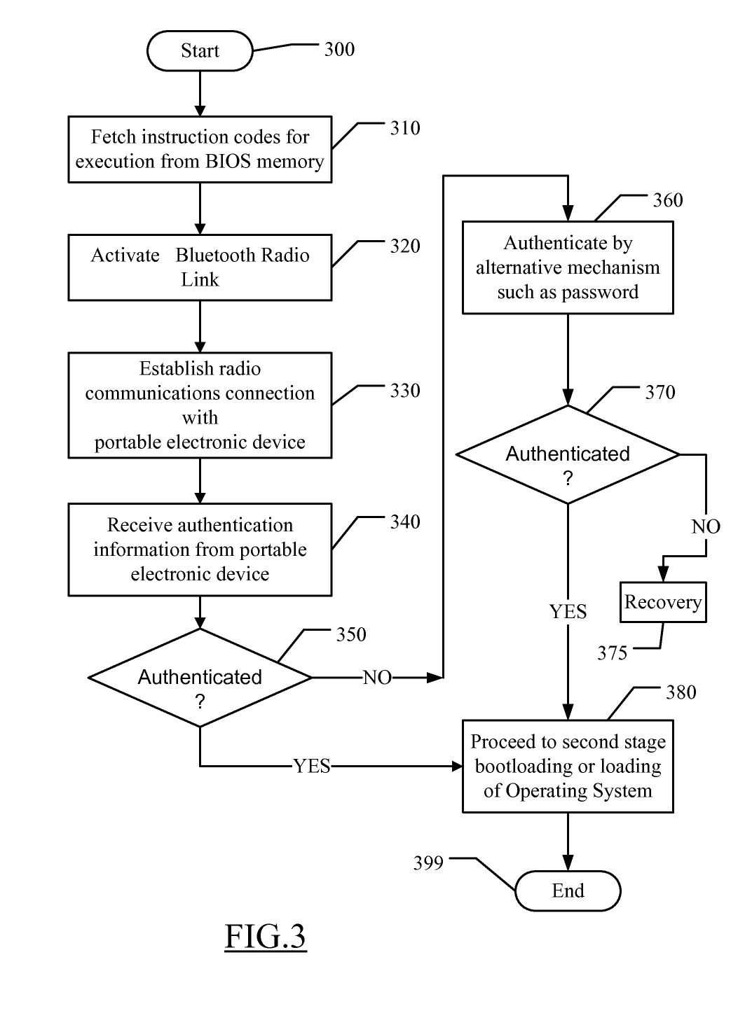

FIG. 3 is a flow chart illustrating many of the acts performed by the computing device in concert with a corresponding platform management device or other portable electronic device, when the computing device interacts therewith and progressing towards authorization of the full operation of the computing device in accordance with an embodiment of the invention.

The chart of FIG. 3 begins with at reference 300 and continues through end at reference 399.

At 310, the processor within the computing device may fetch instruction codes for execution from a memory coupled to the processor, the instruction codes may typically be part of a BIOS or other pre-boot environment codes. The instruction codes will be interpreted and executed by the processor to direct its further operation as described below.

At reference 320 the communications link with the portable electronic device is activated. As discussed above this will typically involve use of a Bluetooth radio communication and the Bluetooth protocol stack may be less than fully featured and necessarily relatively small since it is implemented for pre-boot execution, has limited capabilities and typically operates in a single-threaded environment.

At 330, a radio communications connection is established with the portable electronic device. This allows a conversation to take place in which the portable electronic device may identify and authenticate itself and then offer authentication information with a purpose of enabling fuller operation of the computing device.

At 340, the computing device receives authentication information from portable electronic device. This authentication information, typically received over the Bluetooth communications link may be subject to various forms of validation. For example it may verify authentication against enrolled data which may be accessible only in the pre-boot environment. The authentication information may take any of various forms, and for example, a Bluetooth device address could provide a distinctive code.

Moreover, stored enrollment information may be made available outside the pre-boot context such as for use in re-authentication by screen-saver programs.

Having received authentication/validation information, at 350 a decision is made as to whether the portable electronic device has authenticated the computing device. If authenticated successfully then loading is progressed at reference 380, below.

If authentication using the portable electronic device is deemed insufficient, either because the Authenticate test at 350, or alternatively if a policy decision requires a two-factor authentication then control passes to reference 360. At 360, authentication by an alternative mechanism such as password, biometric data capture or other means takes place. If, at 370, this secondary authentication is seen to fail to meet the imposed criteria then control may be transferred back to 370 at which a recovery is entered. Such recovery 375 may take any of various general forms, such as to hang (stop) the system operations, count the number of failed attempts and retry or interface with a security product. If restarting there may be various different results produced, for example because radio conditions vary and human vagaries are associated with passwords and biometric data.

Assuming then that authentication has succeeded one way or another then at 380 progress is made to second stage bootloading or loading of an OS (Operating System).

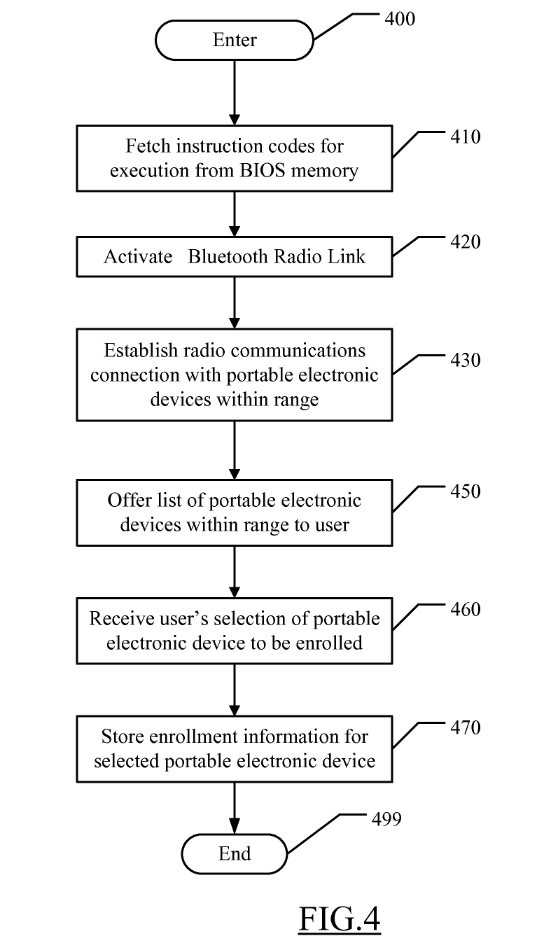

FIG. 4 is a flow chart illustrating many of the acts performed by the computing device in concert with a corresponding platform management device or other portable electronic device in accordance with another aspect or another embodiment of the invention. The chart of FIG. 4 starts with at reference 400 and continues through end at reference 499.

As at 310 and 320 in FIG. 3, at 410 and 420 in FIG. 4, instruction codes are fetched for execution and the communications link (typically Bluetooth radio) is activated in the pre-boot environment.

At 430, radio communications connection is established with all available portable electronic devices within range to compile a list of them. In some communications protocols it may be possible to generate such a list by merely “listening” (receiving without binds a communications session) but either way candidate portable electronic devices for authentication purposes are identified.

At 450 an offer is made of the list of portable electronic devices operable and within useful range so created at 430. Typically this list will be offered for selection of a particular device, the selection being made by a human. However automated (non-human) selection is certainly possible in systems operating within the general scope of the invention. Conceivably the selection might be made on one of the portable electronic devices itself as a possible alternative to selecting using the computing device.

At 460, the user's selection of a particular portable electronic device to be enrolled is received. At 470, the enrollment information for selected portable electronic device is stored for later use for authentication purposes. A provisioning process thus ends at 499.

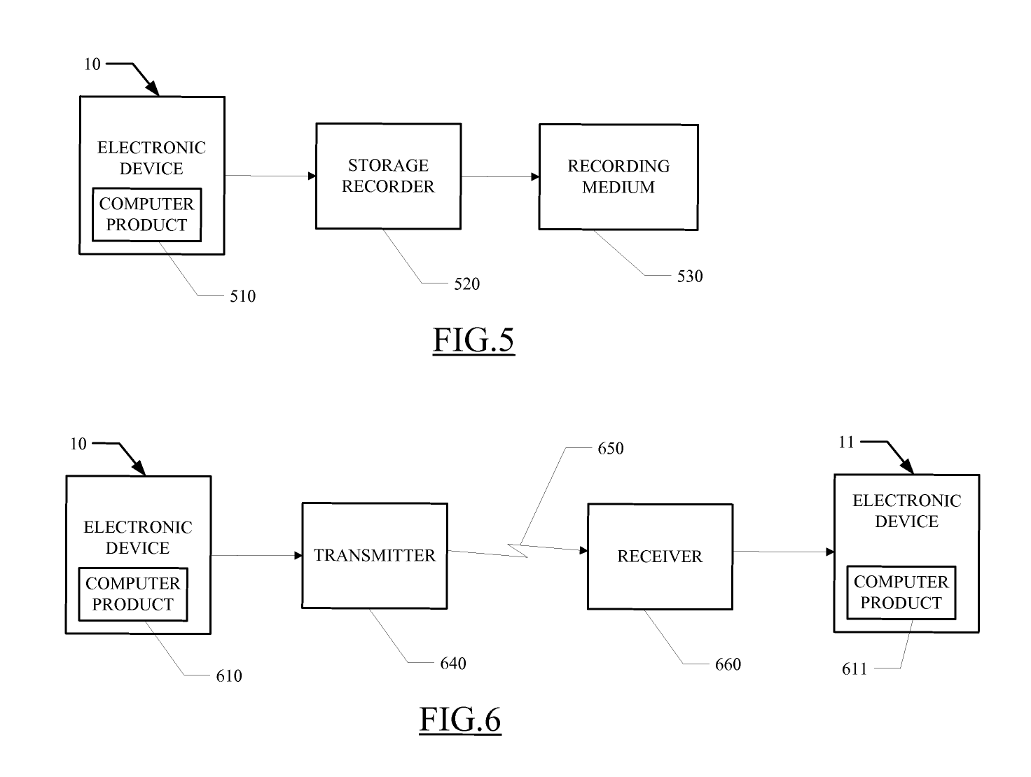

With regards to FIG. 5, computer instructions to be incorporated into in an electronic device 10 may be distributed as manufactured firmware and/or software computer products 510 using a variety of possible media 530 having the instructions recorded thereon such as by using a storage recorder 520. Often in products as complex as those that deploy the invention, more than one medium may be used, both in distribution and in manufacturing relevant product. Only one medium is shown in FIG. 5 for clarity but more than one medium may be used and a single computer product may be divided among a plurality of media.

FIG. 6 shows how an exemplary embodiment of the invention may be encoded, transmitted, received and decoded using electro-magnetic waves.

With regard to FIG. 6, additionally, and especially since the rise in Internet usage, computer products 610 may be distributed by encoding them into signals modulated as a wave. The resulting waveforms may then be transmitted by a transmitter 640, propagated as tangible modulated electro-magnetic carrier waves 650 and received by a receiver 660. Upon reception they may be demodulated and the signal decoded into a further version or copy of the computer product 611 in a memory or other storage device that is part of a second electronic device 11 and typically similar in nature to electronic device 10. In this way one manufactured product (a particularly encoded modulated electro-magnetic carrier wave) may be used to form a derivative manufacture, for example, a ROM (Read-Only Memory) resident BIOS (Basic Input-Output System) according to an embodiment of the invention.

The foregoing detailed description of the invention has been provided for the purposes of illustration and description. Although an exemplary embodiment of the present invention has been described in detail herein with reference to the accompanying drawings, it is to be understood that the invention is not limited to the precise embodiment(s) disclosed, and that various changes and modifications to the invention are possible in light of the above teachings

The embodiments described above are exemplary rather than limiting and the bounds of the invention should be determined from the claims. Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A computing device comprising:
a processor;
a radio comprising a transmitter and a receiver or the radio comprising a transceiver;
and
a first memory coupled to the processor, the first memory maintaining first instruction codes that, when executed by the processor, cause the processor:
to operate the radio to establish a communications connection with a corresponding portable electronic device,
to operate the radio to receive authentication information from the corresponding portable electronic device; and
responsive to the authentication information, to operate to induce a loading of second instruction codes from a second memory.

2. The computing device of claim 1 wherein:
the first memory is a semiconductor memory;
the first instruction codes comprise at least a part of a BIOS (Basic input output system);
the second memory is a mass storage memory; and
the second instruction codes comprise at least a part of an OS (operating system).

3. The computing device of claim 1 wherein the loading of second instruction codes from a second memory is into the first memory.

4. The computing device of claim 2 wherein the loading of second instruction codes from a second memory is into the first memory.

5. The computing device of claim 1 wherein:
the communications connection conforms to the Bluetooth protocol.

6. The computing device of claim 2 wherein:
the communications connection conforms to the Bluetooth protocol.

7. The computing device of claim 1 wherein:
the first instruction codes comprise a Bluetooth protocol stack.

8. The computing device of claim 1 wherein:
the authentication information is a Bluetooth device address.

9. The computing device of claim 1 wherein:
the operate the radio to establish a communications connection and the operate the radio to receive authentication information are each performed substantially within a pre-boot environment and prior to execution of a secondary bootloader program by the computing device.

10. The computing device of claim 9 wherein:
the first memory is a BIOS (Basic Input-Output System) firmware, an EFI (Extensible Firmware Interface) firmware or an embedded system startup firmware.

11. The computing device of claim 2 wherein:
the first instruction codes, when executed by the processor, further cause the processor to store enrollment information for the corresponding portable electronic device in a third memory.

12. The computing device of claim 11 wherein:
the enrollment information is verified by the execution of further instruction codes by computing device after exit from the pre-boot environment.

13. The computing device of claim 2 wherein:
the first instruction codes, when executed by the processor, further cause the processor to identify a plurality of Bluetooth devices within radio range and to offer a list of the plurality of Bluetooth devices within radio range for selection of a particular Bluetooth device for enrollment.

14. The computing device of claim 2 wherein:
the first instruction codes, when executed by the processor, further cause the processor to provide two-factor authentication.

15. A computer program product comprising:
at least one computer-readable medium having instructions encoded therein, the instructions when executed by at least one processor cause said at least one processor to
operate by steps comprising the acts of:
operating the radio to establish a communications connection with a corresponding portable electronic device,
operating the radio to receive authentication information from the corresponding portable electronic device; and
responsive to the authentication information, inducing a loading of second instruction codes from a second memory.

16. The computer program product of claim 15 wherein:
the communications connection conforms to the Bluetooth protocol.

17. A method comprising:
an act of modulating a signal onto an electro-magnetic carrier wave impressed into a tangible medium, or of demodulating the signal from the electro-magnetic carrier wave, the signal having instructions encoded therein, the instructions when executed by at least one processor causing said at least one processor to:
operate by steps comprising the acts of:
operating the radio to establish a communications connection with a corresponding portable electronic device,
operating the radio to receive authentication information from the corresponding portable electronic device; and
responsive to the authentication information, inducing a loading of second instruction codes from a second memory.
